(19) United States
(12) Patent Application Publication
(10) Pub. No.: US 2007/0004915 A1
(43) Pub. Date: Jan. 4, 2007

(54) Process for obtaining hydroxypropylstarch (HPS) for use in the treatment of drilling wells

(76) Inventor: Pedro Tocchetto Thormann, Santa Catarina (BR)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 11/261,926

(22) Filed: Oct. 31, 2005

(30) Foreign Application Priority Data
Jun. 30, 2005 (BR) 0502652-0

(51) Int. Cl. C08B 33/04

(52) U.S. Cl. 536/111

(57) ABSTRACT

Hydroxypropylstarch (HPS) can be used to treat and maintain drilling wells. HPS decreases filtrate loss in muds of petroleum drilling fluids and is effective at high temperature and pressure. This compound may be obtained by reaction of starch with 1-chloro-2,3-epoxy-propane in approximately eight hours.

This application claims priority to Brazilian Patent Application 0502652-0 filed on Jun. 30, 2005, in the name of Pedro Tocchetto Thormann, the contents of which are incorporated herein by reference.

### BACKGROUND OF THE INVENTION

The present invention relates to the production of a chemical product to be used in the drilling and maintenance of underground formed wells. Hydroxypropyl-starch or HPS is a modified starch, which can be used in fluid brines of drilling, maintenance and conclusion operations of soil deep layers. The main purpose of HPS is to decrease of the filtrate loss in muds of petroleum drilling fluids in a manner that is effective at high temperature and pressure.

HPS is employed in the survey and exploration, or search, of petroleum in sedimentary regions, where the petroleum wells are located. The wells reach up to 6,000 meters deep. In soil drilling through probes, water-based muds or fluids are used, as in this case, but there is also the use of oil. The fluid, employed to allow the optimum performance of the probe that perforates the soil and carries the material disaggregated by the drill, is made of water that contains a number of chemical products that are specific for each desired purpose. Among the products used in the fluid set is hydroxypropylstarch (HPS).

The HPS production process which comprises the state-of-technique requires a closed reactor with reflux, aqueous solution, alkaline medium, alkaline metal neutral salts and propylene oxide. Two preparation processes must be carried out in processes that use propylene oxide to obtain the final product (hydroxypropylstarch). First, a reaction must be conducted to obtain the reaction product. Second, another reaction is required to gelatinize the product. Thus, the time to obtain the starch may range from at least 8 hours up to 36 hours depending on the desired yield of the product.

### SUMMARY OF THE INVENTION

As discussed in further detail below, the present invention involves a process for making a gelatinized hydroxypropylstarch for use in the treatment of drilling wells comprising the steps of: providing an starch suspension; adding 1-chloro-2,3-epoxy-propane to the suspension; adding an acid to the suspension; reacting the 1-chloro-2,3-epoxy-propane with starch to produce hydroxypropyl starch; and regulating the water content to gelatinize the hydroxypropyl starch.

The hydroxypropylstarch manufacturing process according to the preferred embodiment may be performed in a single step of production, where the product reacts and is gelatinized within a maximum period of 8 hours. Processes according to the preferred embodiment of the present invention also do not require the alkaline metal neutral salt nor do they require the use of propylene oxide. In the preferred embodiment, the substance 1-chloro-2,3-epoxy-propane is used instead of propylene oxide. The HPS produced according to the preferred embodiment reduces the filtrate loss in drilling water-based muds, i.e., it decreases the fluid loss by decreasing penetration of fluids into the soil sedimentary layers. The decrease in filtrate loss is achieved with a small increase of rheology. The increased viscosity occurring in products comprised by the state-of-technique require more energy for the fluid circulation and, therefore, require the use of other products to decrease the excessive viscosity.

### BRIEF DESCRIPTION OF THE DRAWINGS

FIG. 1 shows the structure of hydroxypropylstarch (HPS) which can be manufactured according to embodiments of the present invention.

### DETAILED DESCRIPTION OF THE PREFERRED EMBODIMENTS

The present invention involves a process to obtain a modified starch, hydroxypropylstarch (HPS), which may be used in fluids useful for brine drilling, which has useful application for maintenance and conclusion operations in deep soil layers. The process of making the modified starch comprises the steps of: (1) preparing, in a closed reactor with aspiration, an starch suspension in water at 38% to 44%; (2) while stirring the starch suspension, adding 1-chloro-2,3-epoxy-propane to 0.90% to 5.51% by weight over the starch weight; (3) homogenizing the suspension for two hours, and after the end of homogenization adding 0.77% to 1.44% of organic acid (acid catalyst), which is allowed to react for six more hours; (4) after the reaction in step (3) has been conducted for six hours, interrupting the reaction and correcting the pH to a pH of between 6 and 8 by adding alkali; (5) after correcting for pH, centrifuging and washing the starch suspension three times in order to eliminate or reduce the salt content present in the product; (6) vacuum filtering the product to a 38% to 48% humidity followed by transporting the product to a controlled closed reactor under controlled temperature and pressure; and (7) regulating the water content to complete gelatinization. The final product hydroxypropylstarch (HPS) can be manufactured according to the above process using 1-chloro-2,3-epoxy-propane in approximately eight hours.

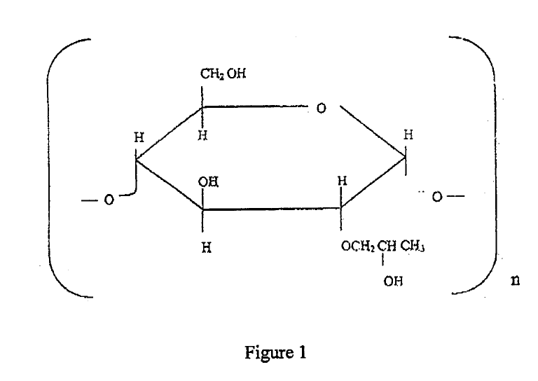

The final product, i.e., the hydroxypropylstarch, which results from the process according to the preferred embodiment is shown by the formula of FIG. 1.

We have observed that, in the process according to the preferred embodiment, there is a reaction phase and later the gelatinization, which complements the degree of gelatinization at the end of the process. This difference is responsible for the reduction of time to obtain the product for a maximum of 8 hours, according to the replacement degree of reaction desired, i.e., the amount of 1-chloro-2,3-epoxy-propane to be reacted. In the processes utilizing propylene oxide, the time to obtain the product may reach up to 36 hours to obtain the same desired product.

Therefore, the inventive concept of the manufacturing process of HPS claimed presents extremely important advantages compared to the existing processes. The fact of using 1-chloro-2,3-epoxy-propane makes the final product (hydroxypropylstarch) to be obtained through a single manufacturing step, where hydroxypropylation and gelatinization occur simultaneously. This results in a decreased time to obtain the final product, which is preferably a maximum time of eight hours.

It is important to note that the process to obtain the hydroxy-propyl-starch also includes its enantiomers. Furthermore, the process may obtain hydroxypropylstarch differing in one or more hydroxyls (OH), or that obtained from different-origin such as roots, tubercles, cereal starches and other existing amylaceous material.

Although the invention has been described with reference to particular embodiments, it is to be understood that these embodiments are merely illustrative of the principles and applications of the present invention. It is therefore to be understood that numerous modifications may be made relative to the illustrative embodiments and that other arrangements may be devised without departing from the spirit and scope of the present invention as defined by the appended claims.

What is claimed is:

1. A process for making a gelatinized hydroxypropylstarch for use in the treatment of drilling wells comprising the steps of:
providing an starch suspension;
adding 1-chloro-2,3-epoxy-propane to the suspension;
adding an acid to the suspension;
reacting the 1-chloro-2,3-epoxy-propane with starch to produce hydroxypropyl starch; and
regulating the water content to gelatinize the hyroxypropyl starch.

2. The process of claim 1, wherein the suspension comprises an starch content of between 38% and 44% in water.

3. The process of claim 1, wherein the 1-chloro-2,3-epoxy-propane is added until the 1-chloro-2,3-epoxy-propane content is in the range of 0.90% to 5.51% of the weight of starch added.

4. The process of claim 1, wherein the suspension is stirred while adding the 1-chloro-2,3-epoxy-propane.

5. The process of claim 1, further comprising a step of homogenizing the suspension adding the acid to the suspension.

6. The process of claim 1, wherein the acid is an organic acid.

7. The process of claim 6, wherein the organic acid is reacted for 6 hours.

8. The process of claim 1, wherein the acid content is 0.77% to 1.44%.

9. The process of claim 1, wherein the organic acid is allowed to react with the starch for six hours before a step of adjusting the pH.

10. The process of claim 9, wherein the pH is adjusted to be greater than about 6.

11. The process of claim 9, wherein the pH is adjusted in the range of about 6 to 8.

12. The process of claim 9, wherein the pH is adjusted by addition of alkali.

13. The process of claim 1, further comprising a step of centrifugation and washing to remove salt.

14. The process of claim 1, wherein the centrifugation and washing is conducted three times.

15. The process of claim 14, wherein the gelatinized hydroxypropyl starch is prepared within eight hours from the step of adding 1-chloro-2,3-epoxy-propane.

16. A method of using the gelatinized hydroxypropylstarch product made by the process of claim 1 in the treatment of drilling wells.

17. The process of claim 1, wherein the starch suspension is obtained from amylaceous material.

18. The process of claim 17, wherein the the amylaceous material is selected from the group consisting of roots, tubercles, and cereal starch.

19. The process of claim 1, wherein a portion of the hydroxypropylstarch is gellatinous prior to the step of regulating the water content to gelatinize the hyroxypropyl starch.
